(19) United States
(12) Patent Application Publication
(10) Pub. No.: US 2018/0026579 A1
(43) Pub. Date: Jan. 25, 2018

(54) FLOATING ISLAND HABITATS AND HEAT SINKS AND ROTATION SYSTEMS FOR COMBINED FLOATING ISLAND SOLAR ARRAYS

(71) Applicant: Fountainhead, LLC, Shepherd, MT (US)

(72) Inventors: Bruce G. Kania, Shepherd, MT (US); Frank M. Stewart, Bozeman, MT (US)

(73) Assignee: Fountainhead, LLC, Shepherd, MT (US)

(21) Appl. No.: 15/655,941

(22) Filed: Jul. 21, 2017

Related U.S. Application Data
(60) Provisional application No. 62/365,404, filed on Jul. 22, 2016.

(51) Int. Cl. H02S 40/44; F24J 2/52; B63B 35/44; F24J 2/34; H02S 10/40; H02S 20/32

(52) U.S. Cl. CPC H02S 40/44; H02S 10/40; H02S 20/32; B63B 35/44; F24J 2/345; F24J 2/5267; B63B 2035/4453

(57) ABSTRACT

Floating islands are provided which have a permeable and buoyant matrix base with a top surface and pores therein and one or more solar panels. The solar panels are fixedly mounted to the matrix such that they are located at or above a waterline of the floating island. A heat sink is attached to at least one of the solar panels. The heat sink is configured to transfer heat from the solar panels to water disposed within the pores of the matrix base such that the solar panels are cooled and the water in the matrix base is warmed. Floating islands may also have a rotation system configured to rotate the matrix base such that the solar panels are facing the sun. The rotation system includes a pivot post, a cable windlass, a first cable coupled to the cable windlass, and a second cable coupled to the cable windlass.

### CROSS-REFERENCE TO RELATED APPLICATION

This application is a non-provisional of and claims priority to and benefit of U.S. Patent Application Ser. No. 62/365,404, filed Jul. 22, 2016, which is hereby incorporated by reference in its entirety.

### FIELD OF THE DISCLOSURE

The following disclosure relates to floating island habitats for cleaning contaminated water combined with solar energy generating systems. The disclosure further relates to heat sinks and rotation systems for combined floating island solar arrays.

### BACKGROUND

Aquatic biofilm growth rates are affected by water temperature, and generally increase with temperature over a range of about 5° to 35° Centigrade. Therefore, when the temperature of a water body is less than about 35° Centigrade, biofilm growth rates can be increased by raising the water temperature. Since the uptake of contaminants by biofilms is proportional to the growth rates of the biofilm, warming the water that is in contact with biofilms increases the efficacy of the contaminant removal from the water. Accordingly, floating islands and other manufactured habitat structures designed to clean bodies of water can benefit significantly from mechanisms that warm the water flowing through them.

With existing solar panel technology, only a relatively small fraction (for example, 10% to 25%) of the sunlight energy striking a solar panel is converted to electrical energy, while a larger fraction (for example, 60% to 80%) of the sunlight energy is converted to heat. This heat can cause a rise in temperature of the photovoltaic cells within the solar panel, and this temperature rise, if excessive, can have both short-term and long-term deleterious effects on the solar panel. In the short term, electrical power output from a typical solar panel is inversely proportional to the temperature of the panel. Therefore, for a given intensity of sunlight, electrical power output from the solar panel becomes smaller as the temperature of the panel rises. In the long term, excessive heat damages the photovoltaic cells of the solar panel and permanently reduces their electrical output. Also, mechanisms to rotate solar panel arrays are used to increase the percentage of sunlight energy effectively converted to electrical energy.

Accordingly, there is a need for devices, systems, and methods to increase the temperature of water flowing through habitat structures designed to remove contaminants from bodies of water. There is also a need for devices, systems, and methods to disperse heat from solar panels. Thus, there is a need for systems and methods combining solar energy with floating island habitats which can channel the heat from solar panels to raise the temperature of water in the habitat structures. There is also a need for a rotation system for solar panels that can be used in combined solar energy floating island systems.

### SUMMARY

The present disclosure, in its many embodiments, alleviates to a great extent the disadvantages of known floating island habitats by providing a floating island structure that comprises one or more photovoltaic solar panels, a porous, permeable and buoyant three-dimensional matrix, and an optional mechanism for transferring solar-generated heat from the solar panels to the water within the pore spaces of the matrix. The optional transfer of heat from the solar panels to the water within the matrix is beneficial for the operational efficiency of the solar panels and for the growth rate of beneficial biofilms within the matrix. More particularly, the object of the optional heat transfer mechanism of the present invention is to transfer heat away from the solar panels and into the water within the matrix, thereby simultaneously increasing the efficacy of both the electrical power generation and the contaminant removal features of the present invention.

Exemplary embodiments of a floating island comprise a permeable and buoyant matrix base having a top surface and defining pores therein and one or more solar panels. The solar panels are mounted to the matrix such that they are located at or above a waterline of the floating island. In exemplary embodiments, the solar panels are located at or above the top surface of the matrix base. A heat sink is attached to at least one of the solar panels. The heat sink is configured to transfer heat from the solar panels to water disposed within the pores of the matrix base such that the solar panels are cooled and the water in the matrix base is warmed.

In exemplary embodiments, the heat sink is attached to an underside of at least one of the solar panels and extends into the matrix base. The heat sink may be a recirculating fluid system comprising a pipe forming a continuous loop. In exemplary embodiments, the heat sink is a fluid sprayer system comprising a water pump and a spray nozzle. Exemplary floating islands may further comprise a circulation pump in fluid communication with the matrix base and configured to move water through the pores of the matrix base. The floating islands may further comprise a rotation system configured to rotate the floating island such that the solar panels are facing the sun.

Exemplary embodiments of a floating island comprise a permeable and buoyant matrix base having a top surface and defining pores therein and one or more solar panels. The solar panels are fixedly mounted to the matrix such that they are located at or above a waterline of the floating island. A rotation system is configured to rotate the matrix base such that the solar panels are facing the sun. The floating island may further comprise a heat sink attached to at least one of the solar panels. The heat sink is configured to transfer heat from the solar panels to water disposed within the pores of the matrix base such that the solar panels are cooled and the water in the matrix base is warmed.

In exemplary embodiments, the rotation system comprises a pivot post, a cable windlass, a first cable coupled to the cable windlass, and a second cable coupled to the cable windlass. When the cable windlass rotates in a clockwise direction tension is applied to the first cable and slack is provided to the second cable such that the matrix base rotates around the pivot post in a clockwise direction. When the cable windlass rotates in a counterclockwise direction slack is applied to the first cable and tension is provided to the second cable such that the matrix base rotates around the pivot post in a counterclockwise direction. When the cable windlass is fixed and locked the matrix base is restrained against rotational movement. A computer may be provided to control the rotation system.

Exemplary embodiments of a floating island system comprise at least two permeable and buoyant matrix bases, each matrix base having a top surface and defining pores therein. One or more solar panels are mounted to outside edges of the matrix bases via one or more support frames such that the solar panels extend over open water. One or more heat sinks are attached to at least one of the support frames and extend into a supporting body of water. The heat sinks are configured to transfer heat from the solar panels to the supporting body of water.

A first advantage of embodiments of the present disclosure is that they provide relatively warmer water to beneficial biofilms and periphyton growing with the matrix, thereby increasing the biological removal rate of water-borne contaminants in the waterbody in which disclosed embodiments are deployed. The warmer water can also expand the reproduction period for minnows and other fauna, thereby promoting the effect of “moving the contaminants up the food chain,” wherein undesirable compounds such as excess nitrogen and phosphorus are sequentially converted into biofilms, then into insects and small fish, and then into edible fish.

A second advantage of embodiments of the present disclosure is that they block sunlight that would otherwise enter the waterbody. The effect of this shaded portion of the water surface is to reduce sunlight available to phytoplankton (free-floating algae), thereby reducing the growth rate of these organisms. Phytoplankton can be undesirable in a waterbody because they reduce water clarity, and in extreme cases of algal bloom die-offs, can cause temporary depletion of dissolved oxygen, which is lethal to fish and other aquatic fauna. The reduced levels of sunlight energy within and beneath the present invention enable diatom algal biofilm species to outcompete planktonic algae species. The amount of transmitted sunlight may be designedly controlled to optimize a floating island structure for diatom growth at a particular geographical location, based on available sunlight, temperature, and other environmental conditions. Since diatom biofilms do not experience the “bloom and die-off” cycles typical of planktonic algae, diatoms biofilms provide a relatively consist source of dissolved oxygen to the waterbody, as compared to planktonic algae. In addition, diatom biofilms provide a more concentrated and readily available food source for most aquatic fauna compared to planktonic algae.

A third advantage of embodiments of the present disclosure is that they provide a net cooling effect to the waterbody, by converting a first portion of the incident sunlight to electricity and reflecting a second portion of the incident sunlight back into the atmosphere. Therefore, although water within the matrix of the present invention is warmed, overall average water temperature of the waterbody is reduced. Cooler water is typically advantageous for overall water quality during hot weather conditions in tropical and temperate climates, because it can hold more dissolved oxygen than warmer water.

A fourth advantage of embodiments of the present disclosure is that they can provide a localized ice-free zone around its perimeter during cold weather periods due to warm water seeping out through the permeable matrix. This ice-free zone allows the present invention to be easily rotated so that its solar panels may be optimally oriented in order to capture maximum sunlight energy during periods of low available sunlight.

A fifth advantage of the present invention is that the buoyancy of the buoyant matrix may be easily adjusted during or after manufacture to support the weight of a particular solar panel system that is required for a particular application. This buoyancy adjustment is made during manufacture by injecting more or less uncured foam resin into the pore spaces of the matrix material. Additional foam resin may also be injected into the matrix after the floating island structure has been deployed, if desired.

A sixth advantage of embodiments of the present disclosure is that the amount of heat energy transfer from the solar panels to the water within the matrix may be designedly adjustable. For example, more heat sinks and higher circulation flowrates may be manufactured into units that are designed for colder waters compared to those designed for warmer waters.

A seventh advantage of embodiments of the present disclosure is that the island modules do not behave identically to conventional floating structures. Waves do not reflect off of our island matrix. Instead, they sparge into it. Thus, the “energy” of a wave is spread out over a longer period. To exemplify this, one can point a garden hose at the sidewall of an island module, and the water does not splash back. Instead it enters the matrix, and then drops out vertically a foot or so later. The result of this is that islands do not rock with wave action. Even given 65 mph winds, the islands do not rock. This means that a solar island array will be more stable than a solar array mounted on conventional floating structures, like pontoons.

An eighth advantage of embodiments of the present disclosure is that, while they can allow growth of plants, disclosed biofilm reactors do not require plants. Accordingly, for example in an anaerobic waste water pond setting, solar panels may be mounted directly on top of floating islands since it can be disadvantageous to allow open water. Such settings could include either short growth habit plants or no plants, at designer's discretion. The same option will be available in a conventional lake setting where, for example, solid shade may be desirable to shade out underwater plants.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a side cross-section view of an exemplary embodiment of a floating island in accordance with the present disclosure;

FIG. 1A is a side view of an exemplary embodiment of a floating island in accordance with the present disclosure;

FIG. 2 is a side cross-section view of an exemplary embodiment of a floating island in accordance with the present disclosure;

FIG. 3 is a side cross-section view of an exemplary embodiment of a floating island in accordance with the present disclosure;

FIG. 4 is a side cross-section view of an exemplary embodiment of a floating island in accordance with the present disclosure;

FIG. 5 is a side view of an exemplary embodiment of a floating island in accordance with the present disclosure;

FIG. 6 is a schematic top view of an exemplary embodiment of a floating island in accordance with the present disclosure;

FIG. 7 is a schematic top view of an exemplary embodiment of a floating island in accordance with the present disclosure;

FIG. 8 is a schematic top view of an exemplary embodiment of a floating island in accordance with the present disclosure;

FIG. 9 is a detail view of an exemplary embodiment of a floating island in accordance with the present disclosure;

FIG. 10 is a detail view of an exemplary embodiment of a floating island in accordance with the present disclosure;

FIG. 11 is a side view of an exemplary embodiment of a floating island in accordance with the present disclosure; and

FIG. 12 is a top view of an exemplary embodiment of a floating island in accordance with the present disclosure.

### DETAILED DESCRIPTION

In the following detailed description of exemplary embodiments of the disclosure, reference is made to the accompanying drawings in which like references indicate similar elements, and in which is shown by way of illustration specific embodiments in which disclosed systems and devices may be practiced. These embodiments are described in sufficient detail to enable those skilled in the art to practice the embodiments, and it is to be understood that other embodiments may be utilized and that logical, mechanical, functional, and other changes may be made without departing from the scope of the present disclosure. The following detailed description is, therefore, not to be taken in a limiting sense, and the scope of the present disclosure is defined only by the appended claims. As used in the present disclosure, the term “or” shall be understood to be defined as a logical disjunction and shall not indicate an exclusive disjunction.

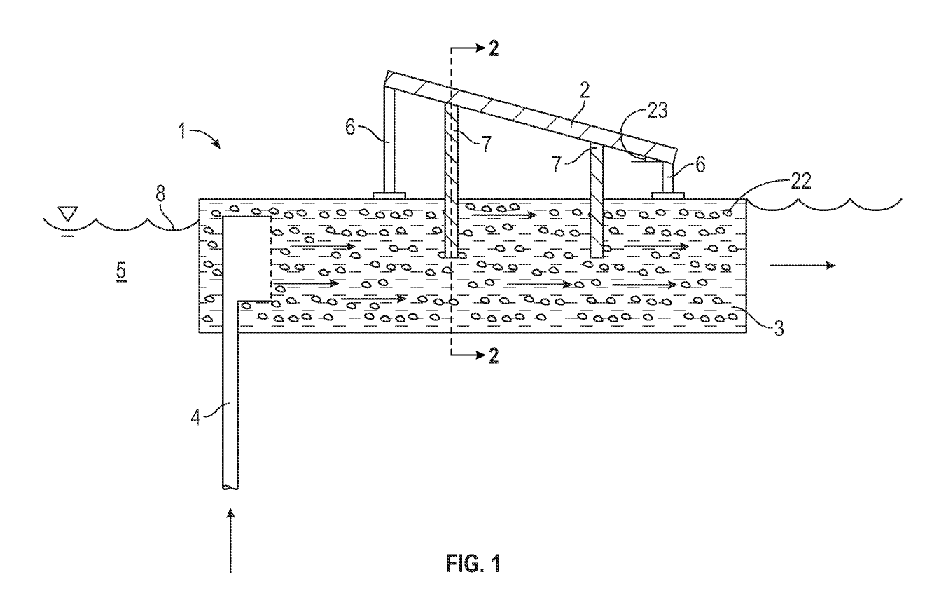

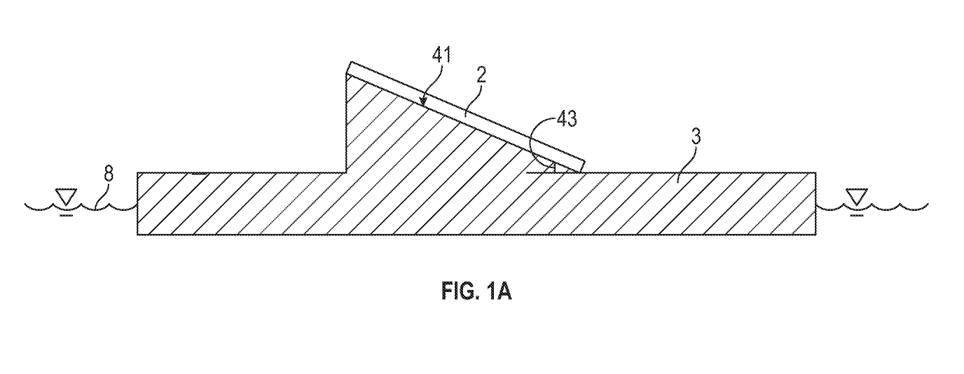

FIGS. 1-5 show exemplary embodiments of a floating island with solar panels. Exemplary floating islands 1 comprise one or more photovoltaic solar panels 2, a porous, permeable and buoyant three-dimensional matrix 3, and an optional mechanism for transferring solar-generated heat from the solar panels to the water within the pores 22 of the matrix. The solar panels 2 may be of a conventional design comprising multiple photovoltaic cells housed within a protective case. In exemplary embodiments, the solar panels are mounted at or above the waterline 8 of the waterbody in which the floating island structure is installed, and are mounted above the top surface of the matrix 3.

The solar panels 2 produce electricity which may be used to power external electrical devices or fed into a commercial power grid to generate revenue. In exemplary embodiments, the matrix 3 is comprised of nonwoven polymer fibers that are bonded together with a binder material. The matrix fibers may be injected with buoyant foam that fills a portion of the pores 22 and provides buoyancy for the floating island structure. In exemplary embodiments, the matrix fibers are optimized for colonization and rapid growth of beneficial biofilms that remove contaminants (such as dissolved nitrogen and phosphorus from fertilizer runoff) from the water body and provide a food source for insects, fish, and other animals. In exemplary embodiments, the floating island structure 1 comprises a circulation pump 4 that moves water through the unfoamed pores 22 of the matrix.

FIG. 1 is a simplified schematic side view of an exemplary embodiment of a floating island structure that comprises solar panels equipped with structural heat sink elements. As shown in FIG. 1, the floating island structure 1 comprises a solar panel 2, a buoyant matrix 3, and a circulation pump 4. In exemplary embodiments, the solar panel 2 is connected to the buoyant matrix 3 by support frames 6 that may be conventional solar panel frames manufactured from aluminum or fiberglass structural members. The buoyant matrix 3 of exemplary embodiments is typically manufactured from multiple layers of nonwoven matting, wherein the matting layers are stacked vertically and bonded together with foam adhesive. A structural grid or grating layer may optionally be incorporated into the buoyant matrix by installing it between two layers of nonwoven matting.

Alternately, as shown in FIG. 1A, the solar panels 2 may be installed directly onto the top surface 41 of the buoyant matrix 3, and the top surface 41 of the matrix may be constructed at a designable slope 43 to provide a desired inclination to the solar panels. The solar panel 2 is shown mounted at an inclined angle 23 with respect to the horizontal, but may be mounted flat or at any inclined angle as preferred for a particular installation. Although a single solar panel 2 is shown, the number of solar panels on a particular floating island structure 1 may be varied depending on the size of the floating island structure 1 and other design criteria.

In exemplary embodiments, heat sinks 7 are attached to the underside of the solar panel 2 and extend into the buoyant matrix 3 to a depth below the waterline 8. Although FIG. 1 shows two heat sinks 7, the number of heat sinks mounted on each solar panel can be varied depending on solar panel size and other design criteria. The heat sinks 7 absorb heat energy from the solar panel 2 and transmit the heat energy into water within the buoyant matrix 3, thereby cooling the solar panels 2 while simultaneously warming the water within the buoyant matrix 3. The circulation pump 4 pulls cool water from the waterbody 5 at a location underneath the floating island structure 1 and pushes the cool water through the buoyant matrix 3, as illustrated by the arrows.

As the water passes through the buoyant matrix 3, it absorbs heat from the heat sinks 7, and delivers a continuous fresh supply of contaminant-laden water to the biofilms growing within the buoyant matrix 3. After traveling through the buoyant matrix 3, the water is released back into the water body 5. The circulation pump 4 may be any conventional type of water pump, and may optionally be an airlift pump, which injects air bubbles into the water stream as it enters the buoyant matrix 3, thereby supplying oxygen to aerobic bacteria that comprise the biofilms growing within the buoyant matrix 3.

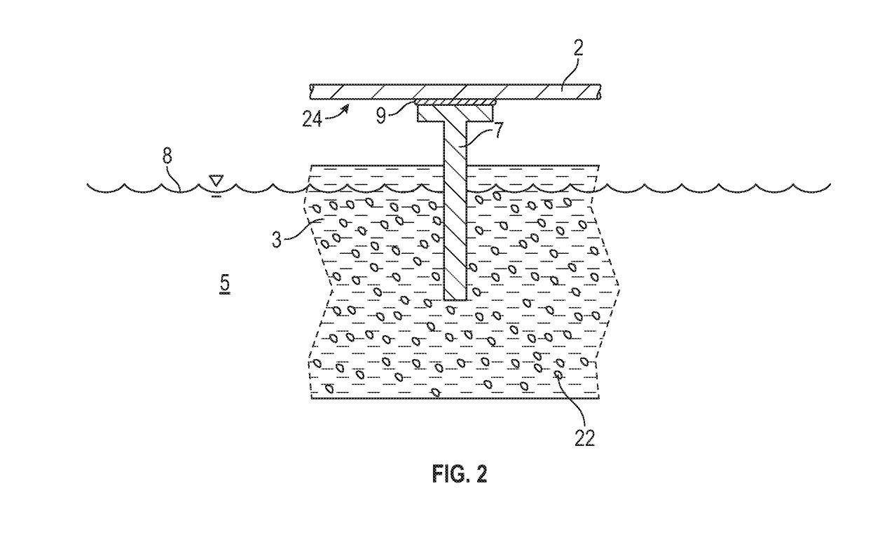

FIG. 2 is a detail cross section view of the floating island structure shown in FIG. 1 taken at the section line shown in FIG. 1. As shown in FIG. 2, the upper end of heat sink 7 is attached to the underside 24 of the solar panel 2, while the lower portion of the heat sink 7 extends into the buoyant matrix 3 to a depth below the waterline 8. A chemical bonding agent 9 may be used to attach the heat sink 7 to the solar panel 2, although the attachment may be made with bolts or other structural fasteners.

The efficiency of the heat transfer from the solar panel 2 to the heat sink 7 may be optimized by using chemical bonding agent 9 that comprises thermal interface material (TIM) containing thermally conductive additives such as graphene, aluminum or silver. One example of a commercial supplier of TIM products is Arctic Silver Incorporated of Visalia, Calif. The heat sink 7 is preferably comprised of high thermal conductivity material such as aluminum or copper. The heat sink 7 shown in FIG. 2 is T-shaped in cross section, but other shapes such as I beams may be employed. The heat sinks 7 may be installed into the buoyant matrix 3 into cutouts that are made into the buoyant matrix.

It should be noted that the passive heat conductor sidewall that supports the solar panels can extend down and be attached to the rigid grate that extends horizontally between the modules. If the sidewall and the grating is of heat conductive materials, like aluminum or the other materials discussed herein, then there will be a lot of additional heat exchange surface area to work with.

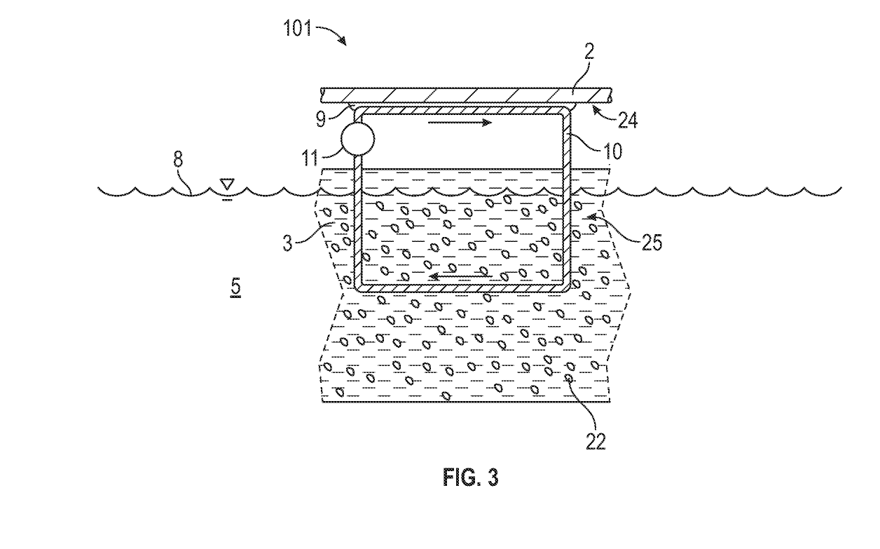

FIG. 3 is a simplified schematic cross section view of an exemplary embodiment of a floating island structure 101 that comprises solar panels 2 equipped with a recirculating fluid system 25 to transfer heat from the solar panels 2 to the water within the buoyant matrix 3. As shown in FIG. 3, a fluid-filled pipe 10 forms a continuous loop whose top portion is attached to the underside 24 of solar panel 2, and whose lower portion extends below the waterline 8 into the fluid-filled portion of the buoyant matrix 3. A recirculation pump 11 is used to circulate the fluid through the pipe 10. The top portion of the pipe 10 is preferably attached to the underside of the solar panel 2 with a chemical bonding agent 9, which optionally may contain TIM, as described previously with reference to FIG. 2.

As fluid circulates through pipe 10, it absorbs heat from the solar panel 2 and releases the heat into the water within the buoyant matrix 3, thereby transferring heat from the solar panel 2 into the water within the buoyant matrix 3. The solar panels 2 may be attached to the buoyant matrix 3 with a support frame (not shown) in the manner shown in FIG. 1. The recirculation fluid in the pipe 10 may be any suitable liquid such as water or propylene glycol. Although one loop of pipe is shown in FIG. 3, multiple loops may be installed on each solar panel as necessary to provide adequate heat transfer for a specific application.

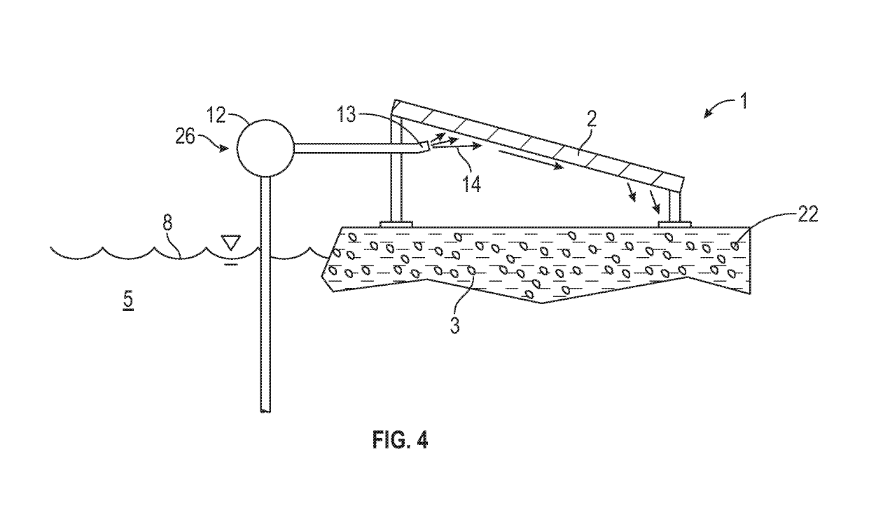

FIG. 4 is a simplified schematic cross section side view of an exemplary embodiment of a floating island structure that comprises solar panels equipped with a fluid sprayer system to transfer heat from the solar panel to the water within the buoyant matrix. As shown in FIG. 4, an exemplary embodiment comprises a solar panel 2 mounted above the top surface of a buoyant matrix 3, and having a cooling system 26 that comprises a water pump 12 and a spray nozzle 13 that draws in water from underneath the buoyant matrix and discharges the water as a pressurized spray 14 onto the underside of the solar panel 2. When the spray 14 contacts the solar panel 2, it absorbs heat from the panel, and then drips into the buoyant matrix 3, where it warms the water within the buoyant matrix 3. In this manner, heat is transferred from the solar panel 2 into the water within the buoyant matrix 3.

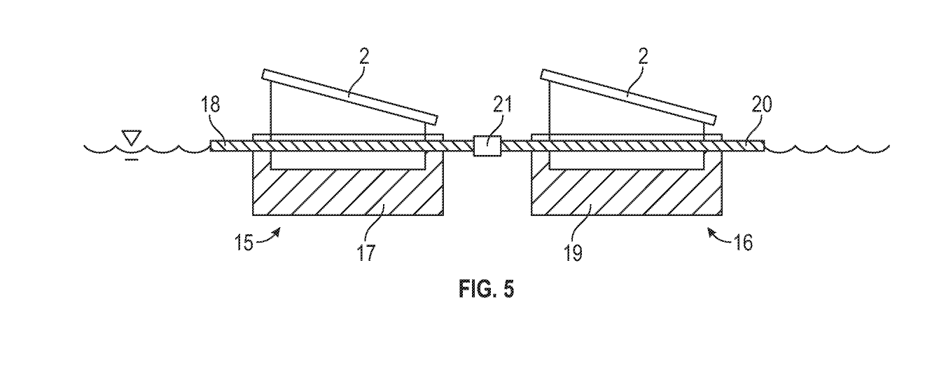

FIG. 5 is a schematic side cross section view of a first floating island module 15 and a second floating island module 16. As shown, the first floating island module 15 comprises first buoyant matrix component 17 and a solar panel 2, wherein a first structural grid 18 is manufactured into the first buoyant matrix component 17. Similarly, the second floating island module 16 comprises a second buoyant matrix component 19 and a solar panel 2, wherein a second structural grid 20 is manufactured into the second buoyant matrix component 19. The first floating island module 15 and the second floating island module 16 are joined by a grid connector 21 that connects one edge of the first structural grid 18 to an adjacent edge of the second structural grid 20. Multiple connectors 21 may be utilized to connect a plurality of floating island modules into rows and columns; for example, 20 identical floating island modules may be connected to form a floating island array that is 5 modules long by 4 modules wide.

The structural grids may be made from commercially available products such as the fiberglass-reinforced walkway panels manufactured by Bedford Reinforced Plastics, Inc., of Bedford, Pa. The structural grids may extend laterally beyond the edges of the buoyant matrix components, as shown in FIG. 5. The structural grids are comprised of strips of plastic or other material manufactured in a grid-shaped pattern with openings between the strips. These openings allow sunlight to be transmitted through the structural grids. The amount of sunlight that is transmitted into the waterbody through an array of floating island modules may be controlled by varying the size of the grid surface area that extends beyond the edges of the buoyant matrix component of each module, or by varying the size of the openings within the structural grid.

In addition to controlling the amount of sunlight entering the waterbody, the structural grids may also be used to provide stiffness and tensile strength to the floating island modules, and to provide walkways between the modules. As previously described, the structural grids also provide a way of connecting multiple modules together by using connectors that attach to the edges of adjacent structural grids.

The structural grids may be attached to the heat sink components described with reference to FIGS. 2 and 3, and thereby be utilized as additional heat sink mass to promote the rapid transfer of heat energy from the solar panels into the water within the buoyant matrix. When the grids are used as heat sinks, they may preferably be manufactured from materials having a high thermal conductivity such as aluminum, or from polymers that incorporate high thermal-conductivity particles such as aluminum, other metals or graphene into the polymer mass.

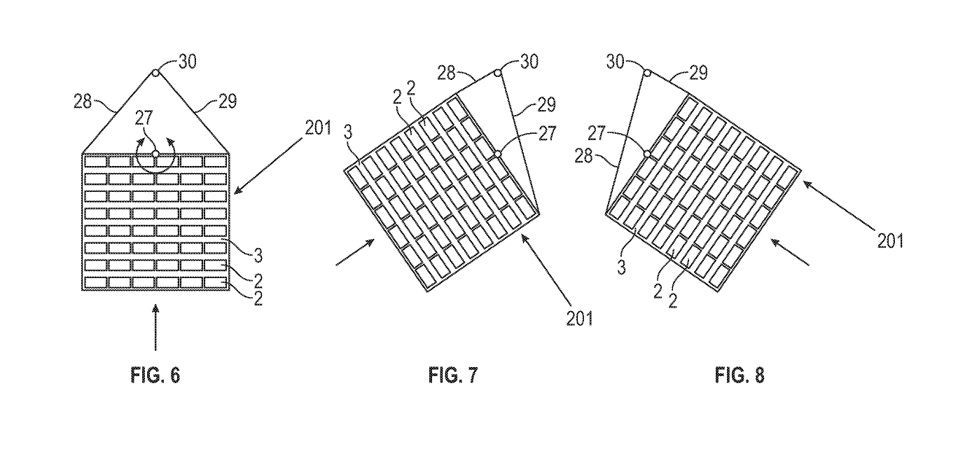

Turning to FIGS. 6-8, exemplary embodiments of floating islands 201 comprise one or more photovoltaic solar panels 2, a porous, permeable and buoyant three-dimensional matrix base 3, and an optional mechanism for rotating the floating island structure on the water surface so that the solar panels are facing toward the sun. FIG. 6 is a schematic top view of an exemplary floating island oriented toward the sun when sunlight is striking the island from a southerly direction, with the direction of incident sunlight depicted by the arrow at the bottom of the figure. As shown, the floating island structure 201 comprises a buoyant matrix base 3, multiple solar panels 2, a pivot post 27, a first cable 28, a second cable 29, and a cable windlass 30. In exemplary embodiments, the solar panels 2 are rigidly mounted to the buoyant matrix base 3.

The buoyant matrix base 3 is capable of rotation about the pivot post 27, as shown by the dashed arrows. The cable windlass 7 may be electrically powered and computer controlled. The cable windlass 30 is capable of rotating in either a clockwise or counterclockwise direction, and is also capable of being in a fixed and locked position. When the cable windlass 30 rotates in a clockwise direction (as best seen in FIG. 6), tension is applied to the first cable 28, while simultaneously, slack is provided to the second cable 29, thereby causing the buoyant matrix base 3 to rotate around the pivot post 27 in a clockwise direction. Conversely, when the cable windlass 30 rotates in a counterclockwise direction, tension is applied to the second cable 29, while slack is provided to the first cable 28, thereby causing the buoyant matrix base 3 to rotate around the pivot post 27 in a counterclockwise direction. When the windlass is fixed and locked, the buoyant matrix base 3 is restrained against rotational movement.

FIG. 7 is a schematic top view of an exemplary embodiment of a floating island structure 201 after the cable windlass 30 has been rotated in a clockwise position (compared to FIG. 6) and then stopped. As shown, the buoyant matrix base 3 has been rotated so that the solar panels 2 are facing toward the southwest, so that they face incident sunlight coming from the southwest direction, as illustrated by the dot-dash arrow.

FIG. 8 is a schematic top view of an exemplary embodiment of a floating island structure 201 after the cable windlass 30 has been rotated in a counterclockwise position (compared to FIG. 6) and then stopped. As shown, the buoyant matrix base 3 has been rotated so that the solar panels 2 are facing toward the southeast, so that they face incident sunlight coming from the southeast direction, as illustrated by the dot-dash arrow.

In exemplary embodiments, the rotation of the cable windlass 30 is computer controlled so that the solar panels are continuously or semi-continuously caused to face toward the direction of incident sunlight as the sunlight direction varies during the daily cycle. In exemplary embodiments, the pivot post 27 and the cable windlass 30 are anchored into the bottom structure below the waterbody in which the floating island structure is deployed, and are strong enough to anchor the floating island structure 201 against forces due to wind and waves. Alternately, for near-shore deployments, the pivot post 27 and/or the cable windlass 30 may be set into solid ground near the shoreline.

It should be noted that there are many variations of cables and windlasses that may be devised to rotate a floating island structure. The key concept here is that the solar panels are fixed to the base, and the entire base is caused to rotate. This differs from most conventional ground-based solar systems in which the solar panels are caused to rotate with respect to the base.

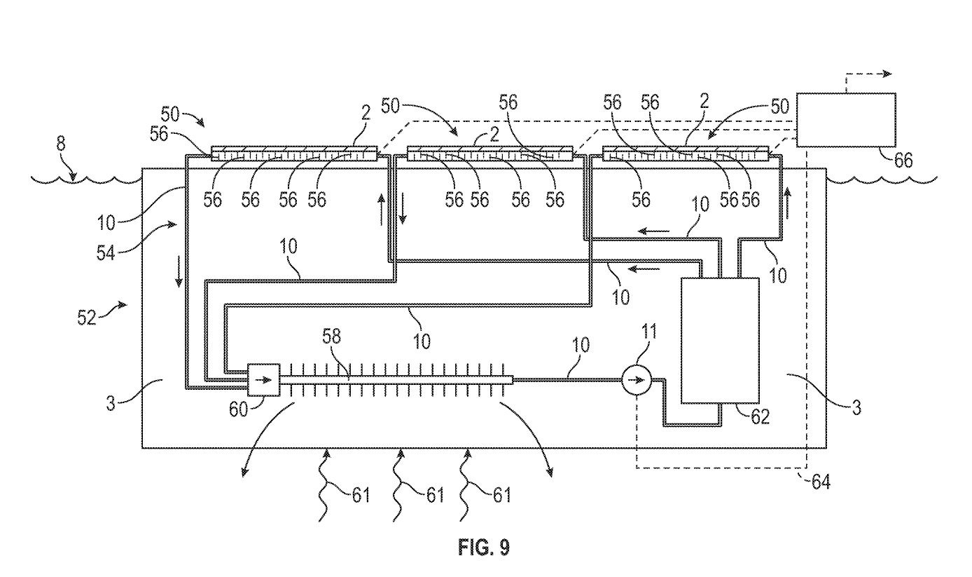

Turning to FIG. 9, an exemplary embodiment of a floating island system incorporating a solar photovoltaic electrical power generator 50 with a solar-heated bioreactor 52 and a recirculating fluid system 54 is shown. Advantageously, this system produces more power because solar panels provide more power when excess heat is removed, and the bioreactor removes contaminants faster at higher temperatures. Solar panels 2 are mounted on one or more liquid-filled backplates 56 attached to the underside of solar panels 2. The backplates 56 feed into a network of pipes 10. More particularly, recirculating fluid system 54 comprises pipes 10 forming a continuous loop whose top portion is attached to the solar panels, and whose lower portion extends below the waterline 8 into the fluid-filled portion of the buoyant matrix 3. A circulation pump 11 may be used to circulate the fluid through the pipes 10, and electrical power provided for the circulation pump from the solar panel electric power output if necessary.

The heat generated by solar panels 2 is transferred away from the panels into the circulation fluid in the liquid-filled backplates 56, through the pipes 10, and then is released into the water-filled bioreactor matrix 3 by a heat exchanger 58 or a radiator. The circulation fluid is sealed and may be propylene glycol or any other suitable circulation fluid. Lagoon water circulation into the buoyant matrix 3 facilitates removal of water-borne contaminants in the waterbody. The system 51 may also incorporate a first manifold 60 serving as a flow collector for the circulation fluid, directing the fluid into the heat exchanger 58. A second manifold 62 or other flow splitter may be provided to split the flow of the circulation fluid among one or more solar panel/backplate units. For purposes of illustration, FIG. 9 shows three such units, but any number of units could be used, depending on the application. The electrical power 64 generated by the solar panels 2 may be routed to a control box 66 and fed to a utility grid or used for local distributed power generation. A portion of the electrical power 64 from the solar panels 2 could be directed to the circulation pump 11.

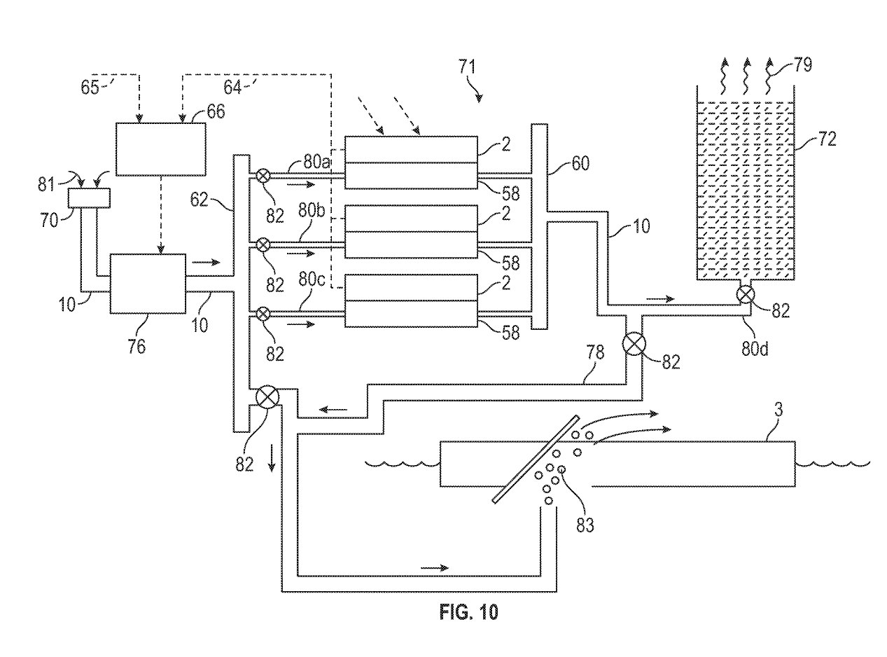

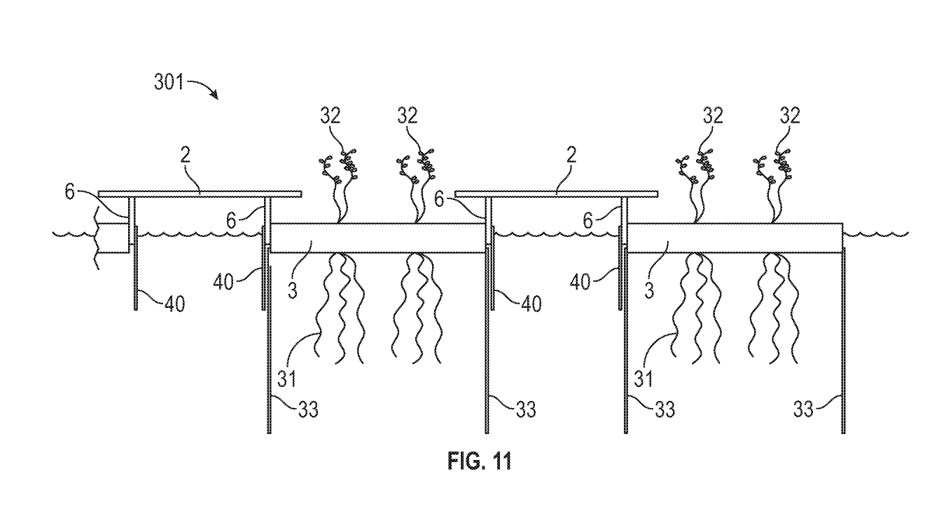

FIG. 10 is a schematic of an exemplary floating island and air circulation system 71 incorporating solar energy and vermiculture. In exemplary embodiments, one or more solar panels 2 are mounted on one or more heat exchangers 58. The heat exchangers 58 are connected to a network of pipes 10. More particularly, the air circulation system 71 comprises pipes 10 whose top portion is attached to the heat exchangers 58, whose lower portion may extend below the waterline into the fluid-filled portion of the buoyant matrix 3, and which ultimately connects to a vermiculture tank 72. In exemplary embodiments, ambient air 81 enters at air inlet 70, travels through a first portion of pipe 10 through a blower 76 and then is directed through a splitter manifold 62 through airflow lines 80a, 80b, 80c into the heat exchangers 58.

After passing through heat exchangers 58, the air, now warmed by the solar panels 2, passes through combining manifold 60 and is directed through airflow line 80d to the vermiculture tank 72 to assist vermiculture growth. Exhaust air 79 may be emitted from the vermiculture tank 72 into the ambient environment. A bypass air line 78 brings some of the air back to the splitter manifold 62. Some of the air 83 may be directed from the bypass air line 78 through an airlift circulation pump (not shown) into permeable bioreactor matrix 3. Various control valves 82 could be utilized as illustrated to regulate airflow. The electrical power 64 generated by the solar panels 2 may be routed to a controller 66 and fed to a utility grid or used for local distributed power generation. Power from the electric grid 65 and/or a portion of the electrical power 64 from the solar panels 2 could be directed to the blower 76.

FIG. 11 is a side view of an exemplary embodiment of a solar island system 301 in which solar panels 2 extend over open water between adjacent buoyant modules. As shown, solar panels 2 are attached to the outside edges of buoyant modules of matrix 3 by means of support frames 6. Fin-shaped heat sinks 40 are attached to the support frames 6 and extend into the water below the depth of the support frames 6. The fin-shaped heat sinks 40 may be manufactured from aluminum sheeting and may be generally rectangular in shape. The fin-shaped heat sinks 40 are positioned to direct the flow of moving water along the underside of the buoyant matrix 3 and through the submerged roots 31 of aquatic plants 32 that grow on the buoyant matrix 3. The submerged roots 31 provide additional surface area for beneficial periphyton biofilms, in addition to the biofilm surface area provided within the buoyant matrix.

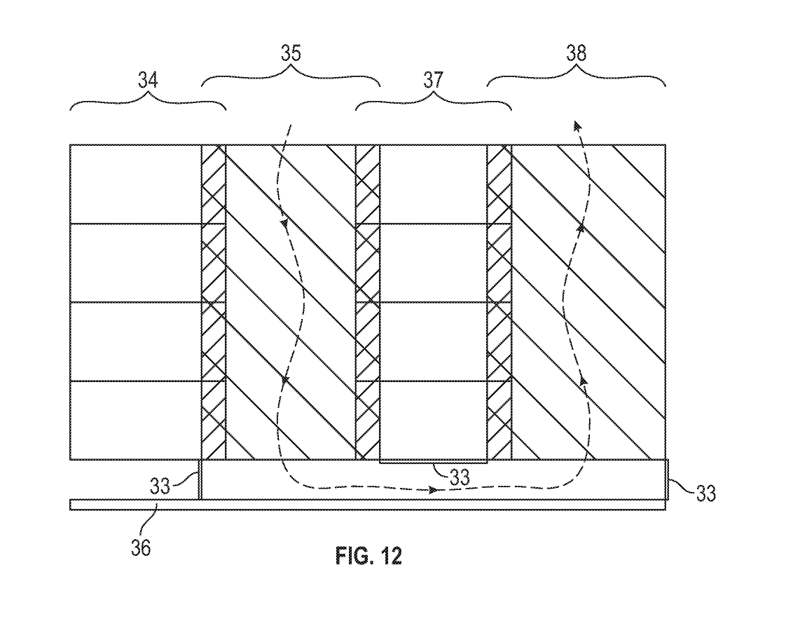

Optional submerged curtains 33 may also be installed along one or more edges of each buoyant module 3 to help constrain the water flow in a desired direction, as shown in FIG. 12. The optional submerged curtains 33 may be manufactured from polymer sheeting, and may be weighted along the bottom edge to help maintain them in a vertical orientation. The fin-shaped heat sinks 40 may be rotated along their vertical and/or horizontal axes to direct the water flow in a specific direction.

FIG. 12 is a top view of two rows of the solar island system shown in FIG. 11. The dashed lines show the direction of water flow. Energy to pump the water is supplied a by pump (not shown) such as an airlift pump. The system comprises a first row of solar panels 34, a first row of buoyant matrix modules 35, an impermeable barrier 36, a second row of solar panels 37 and a second row of buoyant modules 38. As shown by the dashed line, water travels under and through the first row of buoyant modules 35, then strikes the impermeable barrier 36. The impermeable barrier 36 and submerged curtains 33 change the direction of the water flow so that it then travels under and through a second row of buoyant matrix 38. Although two rows of solar panels and buoyant matrix are shown, the system may include any number of rows of solar panels and buoyant matrix.

The impermeable barrier 36 may be manufactured from polymer sheeting, or it may be a solid wall constructed of concrete blocks or other material. Although one particular arrangement of buoyant modules, submerged curtains, and solar panels with fin-shaped heat sinks is illustrated in FIGS. 11 and 12, many other arrangements are possible, based on specific site configurations and objectives. The important concept described here is that fin-shaped heat sinks may be installed onto solar panels that are suspended between buoyant modules to control the direction of water flow as well as to transfer heat from the solar panels.

Thus, it is seen that improved floating islands combined with solar energy systems are provided. It should be understood that any of the foregoing configurations and specialized components or chemical compounds may be interchangeably used with any of the systems of the preceding embodiments. Although illustrative embodiments are described hereinabove, it will be evident to one skilled in the art that various changes and modifications may be made therein without departing from the disclosure. It is intended in the appended claims to cover all such changes and modifications that fall within the true spirit and scope of the disclosure.

While the disclosed systems and devices have been described in terms of what are presently considered to be the most practical exemplary embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A floating island comprising:
a permeable and buoyant matrix base having a top surface and defining pores therein;
one or more solar panels mounted to the matrix base such that the solar panels are located at or above a waterline of the floating island; and
a heat sink attached to at least one of the solar panels, the heat sink being configured to transfer heat from the solar panels to water disposed within the pores of the matrix base such that the solar panels are cooled and the water in the matrix base is warmed.

2. The floating island of claim 1 wherein the heat sink is attached to an underside of at least one of the solar panels and extends into the matrix base.

3. The floating island of claim 1 wherein the heat sink is a recirculating fluid system comprising a pipe forming a continuous loop.

4. The floating island of claim 1 wherein the heat sink is a fluid sprayer system comprising a water pump and a spray nozzle.

5. The floating island of claim 1 further comprising a circulation pump in fluid communication with the matrix base and configured to move water through the pores of the matrix base.

6. The floating island of claim 1 further comprising a rotation system configured to rotate the floating island such that the solar panels are facing the sun.

7. The floating island of claim 1 wherein the solar panels are located at or above the top surface of the matrix base.

8. A floating island comprising:
a permeable and buoyant matrix base having a top surface and defining pores therein;
one or more solar panels fixedly mounted to the matrix base such that the solar panels are located at or above a waterline of the floating island; and
a rotation system configured to rotate the matrix base such that the solar panels are facing the sun.

9. The floating of claim 8 wherein the rotation system comprises:
a pivot post;
a cable windlass;
a first cable coupled to the cable windlass; and
a second cable coupled to the cable windlass.

10. The floating island of claim 9 wherein when the cable windlass rotates in a clockwise direction tension is applied to the first cable and slack is provided to the second cable such that the matrix base rotates around the pivot post in a clockwise direction.

11. The floating island of claim 9 wherein when the cable windlass rotates in a counterclockwise direction slack is applied to the first cable and tension is provided to the second cable such that the matrix base rotates around the pivot post in a counterclockwise direction.

12. The floating island of claim 9 wherein when the cable windlass is fixed and locked the matrix base is restrained against rotational movement.

13. The floating island of claim 8 further comprising a computer to control the rotation system.

14. The floating island of claim 8 further comprising a heat sink attached to at least one of the solar panels, the heat sink being configured to transfer heat from the solar panels to water disposed within the pores of the matrix base such that the solar panels are cooled and the water in the matrix base is warmed.

15. A floating island system comprising:
at least two permeable and buoyant matrix bases, each matrix base having a top surface and defining pores therein;
one or more solar panels mounted to outside edges of the matrix bases via one or more support frames such that the solar panels extend over open water; and
one or more heat sinks attached to at least one of the support frames and extending into a supporting body of water, the heat sinks being configured to transfer heat from the solar panels to the supporting body of water.
